(19) United States
(12) Patent Application Publication
(10) Pub. No.: US 2004/0010530 A1
(43) Pub. Date: Jan. 15, 2004

(54) Systolic high radix modular multiplier

(76) Inventors: William L. Freking, Lexington, MA (US); Keshab K. Parhi, Mission Viejo, CA (US)

Correspondence Address: William L. Freking, 2258 Timberlea Dr., Woodbury, MN, 55125-3001, US

(21) Appl. No.: 10/192,934

(22) Filed: Jul. 10, 2002

(51) Int. Cl. G06F 7/38

(52) U.S. Cl. 708/491

(57) ABSTRACT

A fast, scalable, systolic modular multiplier based on functional array partitioning and high-radix modular reduction is presented. Systolic paradigms of limited fan-out on all signal paths and nearest neighbor interconnections guarantee optimally fast clock rates. Linear throughput scalability with respect to consumed hardware resources is achieved through simultaneous parallel processing of multiple independent data streams. Signal sharing among input and output busses and a common control interface for all independent data streams is made possible, thus benefiting integrated circuit implementations. Reductions in number of delay registers and required number of independent data streams for a given throughput requirement are achieved when interconnection delay does not dominate over processing element delay.

### CROSS-REFERENCE TO RELATED APPLICATIONS

Not applicable.

### BACKGROUND OF THE INVENTION

1. Field of the Invention

The present invention relates to the processing of digital signals to render modular multiplication.

2. Description of Related Art

Modular multiplication, which is the computation of A·B modulo M where A, B, and M are integer values, is a fundamental mathematical operation in applications based on number-theoretic arithmetic. A central application area is cryptography, where techniques such as the popular RSA and DSS methods utilize modular multiplication as the elemental computation. Since large word lengths on the order of thousands of bits are typically processed, hardware approaches to modular multiplication are typically very slow. Existing art attempts to address this deficiency through a handful of approaches.

Linear systolic array approaches dominate the art, with the article C. Walter, “Systolic modular multiplication,” IEEE Transactions on Computers, v. 42, no. 3, pp. 376-378, 1993, being representative. In such an approach, a linear array of processing elements is connected so that all signal paths are formed between adjoining elements only. Thus, signal path lengths are minimized. Accordingly, all signal paths only connect two adjoining elements, guaranteeing unit fan out. The forgoing properties of systolic arrays ensure that the clock rate is determined solely by the processing element delay. However, efforts to scale the performance beyond the level offered by a single linear array have encountered very limited success. Cell optimization is the commonly applied technique to gain performance. However, performance scales only logarithmically with respect to consumed integrated circuit area.

Another method which attempts to provide a performance-area tradeoff is the digit-serial array. In the paper, J. Guo and C. Wang, “A novel digit-serial systolic array for modular multiplication,” in Proc. of the 1998 IEEE International Symposium on Circuits and Systems, v. 2, pp. 177-180, 1998, a digit-serial modular multiplier methodology was presented. However, the arrays were not pipelined, and thus the clock period of the digit-serial cells grows proportionally with digit size. Therefore, performance scaling occurs in a sub-linear fashion for small digit sizes and quickly saturates to yield negligible performance gains for large digit sizes.

A non-systolic array was presented in the article H. Orup, “Simplifying quotient digit determination in high-radix modular multiplication,” in Proc. of the 12th Symposium on Computer Arithmetic, pp. 193-199, 1995. A roughly linear performance-area tradeoff was achieved through retiming of the modular correction loop within the modular multiplication algorithm. However, the clock rate is severely limited by the required full-word-length signal broadcasts of the modular correction selection bit. Thus, the fan out of the aforementioned signal is the complete word length. Implementational efforts to increase the signal drive through transistor sizing destroys the linear performance-area trade off and only provide minor mitigation of the slow-clock-rate obstacle plaguing this methodology.

### SUMMARY OF THE INVENTION

The present invention describes a method for parallel modular multiplication capable of processing multiple independent data streams simultaneously.

An implementation realizing this method consists of a system of three arrays of bit-level processing elements, the partial result array, the partial product array, and the modular correction array, working in conjunction with one another to process concurrent modular multiplication operations. Each array has a column count consistent with the full word length of the modular multiplication problem to be computed. The partial result array consists of a single row of processing elements each performing the bit-wise summation of the current iteration's computed partial product bit, modular correction bit, and partial result bit from the previous iteration. The partial product and modular correction arrays are each responsible for supplying the partial product and modular correction bits, respectively, to the partial result array. Both of the former arrays are multi-row structures with the number of rows determined in accordance with the available integrated circuit implementation area and the desired throughput performance, which scales linearly with row count.

The data stream capacity and operational throughput are directly scalable with the available integrated circuit implementation area. This performance scalability is accomplished while maintaining a systolic paradigm, such that all interconnection paths are locally connected to neighboring processing elements and entail minimal fan out. Thus, the achievable clock rate is maximized and is dictated by the processing element delay rather than by long interconnect paths or loading due to multiple-gate fan out. Moreover, in contrast to isolated parallel modular multiplication arrays, the unified array structure of the present invention incorporates single input and output data buses, thereby reducing global integrated circuit wiring overhead. Additionally, the unified array permits a single controller to be utilized when the modular multiplier is utilized as a component in a higher-level functional unit such as a modular exponentiator.

When interconnect paths are not the dominant source of delay in the integrated circuit implementation environment, the method lessens the required number of independent interleaved streams while achieving the same level of throughput. Simultaneously, the overall register count and operational latency are reduced.

### OBJECTS AND ADVANTAGES OF THE INVENTION

The primary object of this invention is fast parallel processing of modular multiplication. It is an advantage of this invention that multiple independent data streams may be simultaneously processed. The number of data streams is arbitrary, limited only by implementation area.

It is a primary advantage of this method that throughput performance scales linearly with the area of the integrated circuit implementation while maintaining an optimal systolic clock rate. The latter is attained through guaranteeing properties of neighboring interconnections between processing elements and minimal signal fan out.

It is an advantage of this invention that input and output data share signal lines such that the number of internal signal buses in an integrated circuit implementation are reduced.

It is an advantage of this invention that a unified control unit may be utilized when the modular multiplier unit is used in a modular exponentiator.

It is an advantage of this invention that register counts are reduced for a given level of interconnect constraints.

It is an advantage of this invention that latency is reduced for a given level of interconnect constraints.

### BRIEF DESCRIPTION OF THE DRAWINGS

FIG. 1 illustrates the connections between the component arrays which form the modular multiplier

FIG. 2 illustrates the partial result array

FIG. 3 illustrates the partial product array

FIG. 4 illustrates the modular correction array

### DETAILED DESCRIPTION OF PREFERRED EMBODIMENTS

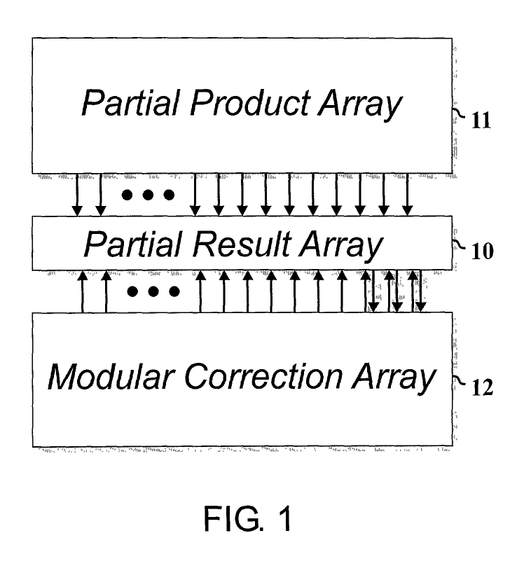

The preferred embodiment is delineated in FIG. 1. It consists of three arrays of interconnected bit-wise processors: the partial result array 10, the partial product array 11, and the modular correction array 12. A fundamental parameter, K, is chosen based on the amount of available integrated circuit area. In general, the throughput performance of the system scales linearly with the parameter K.

The partial result array consists of a single row of N+K cells, where N denotes the length of the modulus in bits. Each cell possesses a set of bit-wise inputs corresponding to the partial product, modular correction, partial sum, and two carry signals. Each cell also possesses a set of bit-wise outputs corresponding to the generated partial sum and two generated carry signals. Each of the cells in columns K through N−1, 1, is interconnected within the structure in the following manner. The partial product input is connected to the partial product array output of corresponding bit significance. Likewise, the modular correction input is connected to the modular correction array output of corresponding bit significance. The two carry outputs are each delayed by one clock cycle and are connected to the corresponding carry inputs of the left-adjacent cell in the partial result array. The partial sum output is delayed by H clock cycles and is connected to the partial sum input of the cell that resides K positions to the right of the current cell. Here, H is an integer parameter chosen such that 1≦H≦K. Note that the partial sum signals may be physically routed through the intervening cells of the array, with the H delays being distributed as evenly as possible among the cell interconnections involved. While this description is operationally equivalent to the former description in terms of processing behavior, it assists in increasing the achievable clock rate in the physical integrated circuit. For instance, when H=K is chosen, the partial sum output of a cell is delayed by one cycle and routed to a pass-through input in the right-adjacent cell. The signal is then output and delayed by one clock cycle and is connected to the subsequent right-adjacent cell. The latter process is repeated until the signal has been displaced a total of K cells to the right. Therefore, one delay element exists prior to each inter-cell excursion within the array, thus guaranteeing minimal interconnect lengths and maximum clock rate.

Cells in columns 0 through K−1, 2, are connected similarly to the above description with the exception that the partial sum output of each cell is delayed by one clock cycle and is delivered as an input to the corresponding bit position of the modular correction array. Furthermore, the carry inputs of the cell of column 0 are grounded.

Cells in columns N through N+K, 3, are also connected similarly to the cells in columns K through N−1 with the exception that the modular correction input is grounded. Moreover, the partial sum of the leftmost cell of column N+K is connected to ground. The single carry output of the leftmost cell is delayed by H+1 clock cycles and is connected to the partial sum input of the cell in column N+1.

The partial sum outputs of all cells in addition to the aforementioned connections are provided as outputs of the system.

Each cell performs the following computation: the partial sum, partial product, modular correction, and two carry inputs are summed. The resultant least significant bit is provided as the partial sum output. The two resultant bits in the most significant bit position are provided as the carry outputs.

Delay elements 4, have one input, and delay the input signal by a specified number of clock cycles before presenting the resultant signal at the single output.

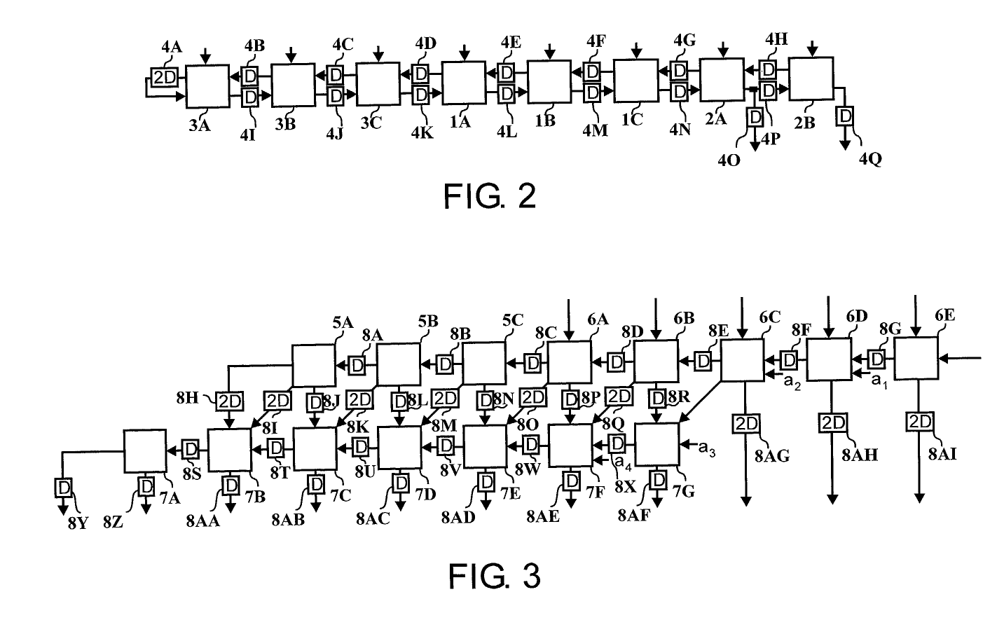

An illustration of the partial result array for the K=2, N=5 case is shown in FIG. 2. Arrays for other parameterizations should be evident to an individual in the field with a grasp of the above description.

The partial product array consists of [(K−1)/2] rows, where [ARGUMENT] denotes the next highest integer when ARGUMENT is not an integer, otherwise [ARGUMENT]=ARGUMENT. The first row consists of N+3 cells, whereas subsequent rows contain N+2 cells. Each cell in the first row, 5, possesses a partial sum input, three multiplicand inputs, three multiplier inputs, and a carry input. Each cell in the first row also possesses a partial sum output, three multiplicand outputs, three multiplier outputs, and two carry outputs. Each of the first N, 6, least significant cells is connected such that one multiplicand input per cell is externally applied. Additionally, each such multiplicand signal is provided to a multiplicand output of the respective cell, which is connected to the remaining multiplicand input of the left-adjacent cell. Such multiplicand inputs are passed through to the remaining multiplicand output, which is delayed by two clock cycles and connected to the below-left-adjacent cell. The multiplicand inputs of the remaining cells in the first row are grounded. One multiplier input for each of the first three least significant cells is externally applied. The remaining multiplier inputs for all cells are derived from the multiplier outputs of the respective right-adjacent cell delayed by one clock cycle. Likewise the carry input is derived from the single-clock-cycle-delayed carry output of the right adjacent cell except in the case of the rightmost cell which has a grounded carry input. All partial sum inputs are grounded, whereas partial sum outputs are delayed by two clock cycles and are connected to the partial sum input of the below-left-adjacent cell.

Each cell in subsequent rows, 7, possesses a partial sum input, two multiplicand inputs, two multiplier inputs, and two carry inputs. Each cell in the first row also possesses a partial sum output, two multiplicand outputs, two multiplier outputs, and two carry outputs. Each multiplicand input derived from the above-right adjacent cell is provided to a multiplicand output of the respective cell, which is delayed by one clock cycle and connected to the multiplicand input of the left-adjacent cell. The latter multiplicand inputs are then passed through to the remaining multiplicand output, which is delayed by two clock cycles and connected to the below-left-adjacent cell if applicable. One multiplier input for each of the first two least significant cells is externally applied. The remaining multiplier inputs for all cells are derived from the multiplier outputs of the respective right-adjacent cell delayed by one clock cycle. Likewise the carry inputs are derived from the single-clock-cycle-delayed carry outputs of the right adjacent cell except in the case of the rightmost cell which has a grounded carry inputs. All partial sum outputs are delayed by two clock cycles and are connected to the partial sum input of the below-left-adjacent cell.

Each cell performs the following computation: each multiplier bit is ANDed with the corresponding multiplicand bit, and the resultant bits along with the carry and partial sum inputs are summed. The resultant least significant bit is provided as the partial sum output. The resultant bit in the most significant bit position is provided as the carry output.

Delay elements 8, have one input, and delay the input signal by a specified number of clock cycles before presenting the resultant signal at the single output.

An illustration of the partial product array for the K=2, N=5 case is shown in FIG. 3. Arrays for other parameterizations should be evident to an individual in the field with a grasp of the above description.

The modular correction array consists of [(K−1)/2] rows. The modular correction array multiplies the least significant K bits of the current partial result by the residue |2^{-K}|_{M}. Therefore, the form of the partial product array derived previously may be reused where the multiplicand inputs now correspond to the corresponding bits of the above residue and the multiplier inputs correspond to the K least significant partial result bits. Given the above connection strategy, the only structural difference between the final form of modular correction array and the partial product array is that the least significant K columns are shifted downward such that the bottommost cell in each column is aligned with the bottom of the array. This step is performed such that no additional interconnect path delay is incurred by physically locating cells far from the partial result array, which resides immediately below the modular correction array in an actual system.

The first class of cells, 9, consists of the topmost least significant N+3 cells. Each cell possesses a partial sum input, three modular residue inputs, three partial result inputs, and a carry input. Each cell in the first row also possesses a partial sum output, three modular residue outputs, three partial result outputs, and two carry outputs. Each of the first N, 13, least significant cells is connected such that one modular residue input per cell is externally applied. Additionally, each such modular residue signal is provided to a modular residue output of the respective cell, which is connected to the remaining modular residue input of the left-adjacent cell. Such modular residue inputs are passed through to the remaining modular residue output, which is delayed by two clock cycles and connected to the below-left-adjacent cell. The modular residue inputs of the remaining cells in the first row are grounded. One partial result input for each of the first three least significant cells is externally applied. The remaining partial result inputs for all cells are derived from the partial result outputs of the respective right-adjacent cell delayed by one clock cycle. Likewise the carry input is derived from the single-clock-cycle-delayed carry output of the right adjacent cell except in the case of the rightmost cell which has a grounded carry input. All partial sum inputs are grounded, whereas partial sum outputs are delayed by two clock cycles and are connected to the partial sum input of the below-left-adjacent cell.

Each of the remaining cells, 14, possesses a partial sum input, two modular residue inputs, two partial result inputs, and two carry inputs. Each cell in the first row also possesses a partial sum output, two modular residue outputs, two partial result outputs, and two carry outputs. Each modular residue input derived from the above-right adjacent cell is provided to a modular residue output of the respective cell, which is delayed by one clock cycle and connected to the modular residue input of the left-adjacent cell. The latter modular residue inputs are then passed through to the remaining modular residue output, which is delayed by two clock cycles and connected to the below-left-adjacent cell if applicable. One partial result input for each of the first two least significant cells is externally applied. The remaining partial result inputs for all cells are derived from the partial result outputs of the respective right-adjacent cell delayed by one clock cycle. Likewise the carry inputs are derived from the single-clock-cycle-delayed carry outputs of the right adjacent cell except in the case of the rightmost cell which has a grounded carry inputs. All partial sum outputs are delayed by two clock cycles and are connected to the partial sum input of the below-left-adjacent cell.

Each cell performs the following computation: each partial result bit is ANDed with the corresponding modular residue bit, and the resultant bits along with the carry and partial sum inputs are summed. The resultant least significant bit is provided as the partial sum output. The resultant bit in the most significant bit position is provided as the carry output.

Delay elements 18, have one input, and delay the input signal by a specified number of clock cycles before presenting the resultant signal at the single output.

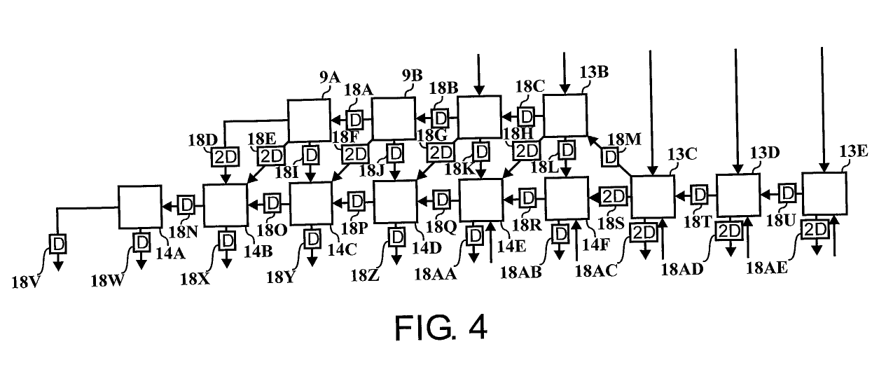

An illustration of the modular correction array for the K=2, N=5 case is shown in FIG. 4. Arrays for other parameterizations should be evident to an individual in the field with a grasp of the above description.

What is claimed is:

1. A machine for processing digital data which performs modular multiplication, comprising:
(a) input lines, transferring a plurality of data comprising:
(1) modular residue words of size N bits, delivered to respective modular residue input bit positions of the modular correction array, and
(2) multiplicand data words of size N+1 bits, delivered to respective multiplicand input bit positions of the modular correction array, and
(3) multiplier data words of size N+1 bits, delivered to respective multiplier input bit positions of the modular correction array, and
(b) output lines which transfer modular product words of size N+1 bits, and
(c) a partial result linear array of processing cells, comprising:
(1) delay elements which transfer an input bit presented during the current clock cycle to the output upon the subsequent clock cycle, and
(2) a plurality of inner cells, numbering N−K and occupying columns K through N−K, where K is a throughput scaling parameter chosen according to available resources, each of which:
(a) computes the binary sum of the partial product input bit, the modular correction input bit, the partial sum input bit, and the two carry input bits, and
(b) transfers the least significant bit of the said binary sum to the partial sum output bit, and
(c) transfers the two most significant bits of the said binary sum to the two carry output bits, and
(d) is connected such that the partial product array output bit of the same column is connected to the said partial product input bit, and
(e) is connected such that the modular correction array output bit of the same column is connected to the said modular correction input bit, and
(f) is connected such that the said two carry outputs are provided to a said delay element whose output is connected to the respective carry inputs of the left-adjacent cell, and
(g) is connected such that the said partial sum output is provided to the modular product output bit of the same column and to a cascade of H delay elements, where H is determined by timing constraints arising from interconnection delays and is bounded according to 1≦H≦K, whose output is connected to the partial result input of the cell located K translations to the right of the current cell, and
(3) a plurality of least-significant cells, numbering K and occupying columns 0 through K−1, each of which:
(a) computes the binary sum of the partial product input bit, the modular correction input bit, the partial sum input bit, and the two carry input bits, and
(b) transfers the least significant bit of the said binary sum to the partial sum output bit, and
(c) transfers the two most significant bits of the said binary sum to the two carry output bits, and
(d) is connected such that the partial product array output bit of the same column is connected to the said partial product input bit, and
(e) is connected such that the modular correction array output bit of the same column is connected to the said modular correction input bit, and
(f) is connected such that the said two carry outputs are provided to a said delay element whose output is connected to the respective carry inputs of the left-adjacent cell, and
(g) is connected such that the partial sum output is provided to the modular product output bit of the same column and to a said delay element whose output is connected to the partial sum input bit of the same column belonging to the modular correction array, and
(4) a plurality of more significant cells, numbering K−1 and occupying columns N through N+K−1, each of which:
(a) computes the binary sum of the partial product input bit, the partial sum input bit, and the two carry input bits, and
(b) transfers the least significant bit of the said binary sum to the partial sum output bit, and
(c) transfers the two most significant bits of the said binary sum to the two carry output bits, and
(d) is connected such that the partial product array output bit of the same column is connected to the said partial product input bit, and
(e) is connected such that the said two carry outputs are provided to a said delay element whose output is connected to the respective carry inputs of the left-adjacent cell, and
(f) is connected such that the said partial sum output is provided to the modular product output bit of the same column and to a cascade of H delay elements, where H is determined by timing constraints arising from interconnection delays and is bounded according to 1≦H≦K, whose output is connected to the partial result input of the cell located K translations to the right of the current cell, and
(5) a most significant cell, occupying column N+K, which:
(a) computes the binary sum of the partial product input bit, the partial sum input bit, and the two carry input bits, and
(b) transfers the least significant bit of the said binary sum to the partial sum output bit, and
(c) transfers the most significant bit of the said binary sum to the carry output bit, and
(d) is connected such that the partial product array output bit of the same column is connected to the said partial product input bit, and
(e) is connected such that the said carry output is provided to a cascade of H delay elements, whose output is connected to the partial sum input of the same cell, and
(f) is connected such that the said partial sum output is provided to the modular product output bit of the same column and to a cascade of H delay elements, where H is determined by timing constraints arising from interconnection delays and is bounded according to 1≦H≦K, whose output is connected to the partial result input of the cell located K translations to the right of the current cell, and
(d) the said partial product array of processing cells comprising:
(1) delay elements which transfer an input bit presented during the current clock cycle to the output upon the subsequent clock cycle, and
(2) a plurality of inner cells, each of which:
(a) computes the binary sum of the partial sum input bit, the two multiplicand input bits ANDed with the respective multiplier input bits, and the two carry input bits, and
(b) transfers the least significant bit of the said binary sum to the partial sum output bit, and
(c) transfers the most significant bit of the said binary sum to the carry output bit, and
(d) transfers the said two multiplicand input bits to respective multiplicand outputs
(e) is connected such that the said two multiplicand outputs are provided to the inputs to respective cascades of two delay elements, the outputs of which are connected to the multiplicand inputs of the below-left adjacent cell, and
(f) is connected such that the said two carry outputs are each provided to a delay element, whose output is connected to the respective carry input of the left-adjacent cell, and
(g) is connected such that the said partial sum output is provided to a delay element whose output is connected to the partial sum input of the below adjacent cell, and
(3) a plurality of least significant cells, each of which:
(a) computes the binary sum of the partial sum input bit, the two multiplicand input bits ANDed with the respective multiplier input bits, and the two carry input bits, and
(b) transfers the least significant bit of the said binary sum to the partial sum output bit, and
(c) transfers the most significant bit of the said binary sum to the carry output bit, and
(d) transfers the said two multiplicand input bits to respective multiplicand outputs
(e) is connected such that the said two multiplicand outputs are provided to the inputs to respective cascades of two delay elements, the outputs of which are connected to the multiplicand inputs of the below-left adjacent cell, and
(f) is connected such that the said two carry outputs are each provided to a delay element, whose output is connected to the respective carry input of the left-adjacent cell, and
(g) is connected such that the said partial sum output is provided to a delay element whose output is connected to the partial sum input of the below adjacent cell, and
(h) is connected such that two of the said external multiplier input bits are delivered to the respective cell multiplier input bits
(4) a plurality of topmost least significant cells, each of which:
(a) computes the binary sum of the partial sum input bit, the three multiplicand input bits ANDed with the respective multiplier input bits, and the two carry input bits, and
(b) transfers the least significant bit of the said binary sum to the partial sum output bit, and
(c) transfers the most significant bit of the said binary sum to the carry output bit, and
(d) transfers the said three multiplicand input bits to respective multiplicand outputs
(e) is connected such that the said three multiplicand outputs are provided to the inputs to a delay element, the outputs of which are connected to the multiplicand inputs of the below-left adjacent cell, and
(f) is connected such that the said two carry outputs are each provided to a delay element, whose output is connected to the respective carry input of the left-adjacent cell, and
(g) is connected such that the said partial sum output is provided to a cascade of two delay elements whose output is connected to the respective partial product input bit of the partial result array, and
(h) is connected such that three of the said external multiplier input bits are delivered to the respective cell multiplier input bits
(5) a plurality of bottom-most inner cells, each of which:
(a) computes the binary sum of the partial sum input bit, the two multiplicand input bits ANDed with the respective multiplier input bits, and the two carry input bits, and
(b) transfers the least significant bit of the said binary sum to the partial sum output bit, and
(c) transfers the most significant bit of the said binary sum to the carry output bit, and
(d) transfers the said two multiplicand input bits to respective multiplicand outputs
(e) is connected such that the said two multiplicand outputs are provided to the inputs to a delay element, the outputs of which are connected to the multiplicand inputs of the below-left adjacent cell, and
(f) is connected such that the said two carry outputs are each provided to a delay element, whose output is connected to the respective carry input of the left-adjacent cell, and
(g) is connected such that the said partial sum output is provided to a delay element whose output is connected to the respective partial product input bit of the partial result array, and
(h) is connected such that two of the said external multiplier input bits are delivered to the respective cell multiplier input bits
(e) the said modular correction array of processing cells comprising:
(1) delay elements which transfer an input bit presented during the current clock cycle to the output upon the subsequent clock cycle, and
(2) a plurality of inner cells, each of which:
(a) computes the binary sum of the partial sum input bit, the two modular residue input bits ANDed with the respective partial result input bits, and the two carry input bits, and
(b) transfers the least significant bit of the said binary sum to the partial sum output bit, and
(c) transfers the most significant bit of the said binary sum to the carry output bit, and
(d) transfers the said two modular residue input bits to respective modular residue outputs
(e) is connected such that the said two modular residue outputs are provided to the inputs to respective cascades of two delay elements, the outputs of which are connected to the modular residue inputs of the below-left adjacent cell, and
(f) is connected such that the said two carry outputs are each provided to a delay element, whose output is connected to the respective carry input of the left-adjacent cell, and
(g) is connected such that the said partial sum output is provided to a delay element whose output is connected to the partial sum input of the below adjacent cell, and
(3) a plurality of least significant cells, each of which:
(a) computes the binary sum of the partial sum input bit, the two modular residue input bits ANDed with the respective partial result input bits, and the two carry input bits, and
(b) transfers the least significant bit of the said binary sum to the partial sum output bit, and
(c) transfers the most significant bit of the said binary sum to the carry output bit, and
(d) transfers the said two modular residue input bits to respective modular residue outputs
(e) is connected such that the said two modular residue outputs are provided to the inputs to respective cascades of two delay elements, the outputs of which are connected to the modular residue inputs of the below-left adjacent cell, and
(f) is connected such that the said two carry outputs are each provided to a delay element, whose output is connected to the respective carry input of the left-adjacent cell, and
(g) is connected such that the said partial sum output is provided to a delay element whose output is connected to the partial sum input of the below adjacent cell, and
(h) is connected such that two of the said partial result input bits from the said partial result array are delivered to the respective cell partial result input bits
(4) a plurality of topmost least significant cells, each of which:
(a) computes the binary sum of the partial sum input bit, the three modular residue input bits ANDed with the respective partial result input bits, and the two carry input bits, and
(b) transfers the least significant bit of the said binary sum to the partial sum output bit, and
(c) transfers the most significant bit of the said binary sum to the carry output bit, and
(d) transfers the said three modular residue input bits to respective modular residue outputs
(e) is connected such that the said three modular residue outputs are provided to the inputs to a delay element, the outputs of which are connected to the modular residue inputs of the below-left adjacent cell, and
(f) is connected such that the said two carry outputs are each provided to a delay element, whose output is connected to the respective carry input of the left-adjacent cell, and
(g) is connected such that the said partial sum output is provided to a cascade of two delay elements whose output is connected to the respective partial product input bit of the partial result array, and
(h) is connected such that three of the said partial result input bits from the said partial result array are delivered to the respective cell partial sum input bits
(5) a plurality of bottom-most inner cells, each of which:
(a) computes the binary sum of the partial sum input bit, the two modular residue input bits ANDed with the respective partial result input bits, and the two carry input bits, and
(b) transfers the least significant bit of the said binary sum to the partial sum output bit, and
(c) transfers the most significant bit of the said binary sum to the carry output bit, and
(d) transfers the said two modular residue input bits to respective modular residue outputs
(e) is connected such that the said two modular residue outputs are provided to the inputs to a delay element, the outputs of which are connected to the modular residue inputs of the below-left adjacent cell, and
(f) is connected such that the said two carry outputs are each provided to a delay element, whose output is connected to the respective carry input of the left-adjacent cell, and
(g) is connected such that the said partial sum output is provided to a delay element whose output is connected to the respective partial product input bit of the partial result array, and
(h) is connected such that two of the said partial result input bits from the said partial result array are delivered to the respective cell partial sum input bits whereby said multiplicand datum and said multiplier datum are multiplied modulo the modulus corresponding to said modular residue datum for each of 2K+H data sets
